(19) United States
(12) Patent Application Publication
(10) Pub. No.: US 2024/0390904 A1
(43) Pub. Date: Nov. 28, 2024

(54) A HIERARCHICALLY ORGANIZED SYSTEM FOR CONTEMPORANEOUS FRACTIONATION OF MULTIPLE FRACTIONS

(71) Applicants: University of Pittsburgh - Of the Commonwealth System of Higher Education, Pittsburgh, PA (US); The Regents of the University of Colorado, a Body Corporate, Denver, CO (US)

(72) Inventors: Kambez Hajipouran Benam, Mars, PA (US); Alexander Joseph Kaiser, Erie, CO (US); Rachel Bogdanoff, Pittsburgh, PA (US)

(21) Appl. No.: 18/688,536

(22) PCT Filed: Sep. 1, 2022
(86) PCT No.: PCT/US2022/042321

§ 371 Date: Mar. 1, 2024

Related U.S. Application Data
(60) Provisional application No. 63/240,035, filed on Sep. 2, 2021.

(51) Int. Cl. B01L 3/00

(52) U.S. Cl. CPC B01L 3/502761; B01L 3/502738; B01L 2300/14; B01L 2400/049; B01L 2400/082

(57) ABSTRACT

A system for fractionating multiple fractions of particles from a sample includes a fractionation unit including a flow channel divided into two or more compartments by one or more porous membranes of known pore size and a flow module system in fluid connection with the fractionation unit. The flow module system further includes a sample container for the sample, a backwash container for a backwash fluid, and two or more collection containers for collection of fractionated portions of the sample, each of the collection containers being in fluid connection with a different one of the compartments. The system further includes a control system in operative connection with the flow module system to control flow.

### CROSS-REFERENCE TO RELATED APPLICATIONS

This application claims benefit of U.S. Provisional Patent Application Ser. No. 63/240,035, filed Sep. 2, 2021, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Many high-throughput, single-cell analytical approaches such as single-cell RNA-sequencing (scRNA-seq) are optimized for standard cell sizes (that is, approximately 8-30 μm) and commonly rely on users to remove cell clumps and debris from suspension (for example, by filtering out sizes >40 μm) prior to a run. This limitation has likely led to the under sampling of large cells (for example, from humans) at health, at disease and at various stages of life (for example, senescent cells, cardiomyocytes, neurons, oocytes, some malignant cells, bone marrow (BM) progenitor cells) by single-cell “OMICs” techniques and in common biomedical research setting for non-OMICs studies. The word “omics” as used herein refers generally to a field of study in the biological sciences in which large amounts of data representing an entire set of some kind is analyzed (for example, genomics, proteomics, etc.).

For instance, mature female egg cells (oocytes) are among the largest cell types with a diameter of approximately 120 μm. Muscle fibers and megakaryocytes (bone-marrow derived or BM cells responsible for the production of blood platelets) can reach a diameter of 100 μm. Senescent cells (which are becoming more and more recognized in the rapidly growing field of senescence) can be greater than 100 μm. A critical technological gap exits in technologies that concurrently isolate cells from dissociated organs/tissues (or in vitro/ex vivo cultures) into multiple fractions to, for example, (1) reveal distribution of cells based on their sizes, (2) allow identification of abundance and visualization of large cells, and (3) support downstream high-resolution, high-throughput analysis of interest—as each fraction can be analyzed independently without filtering cells out. As such, we currently have poor understanding of cell size distribution and presence of large cells in some (for example, senescent) tissues, let alone subjecting those cells to downstream OMICs and non-OMICs analyses for basic and translational scientific discoveries.

Extracellular vesicles or EVs are membranous subcellular structures that are released from healthy and dying cells. They are secreted into the extracellular space, can reach distant tissues, and are found in bodily fluids. EVs are known to facilitate intercellular communication in diverse cellular processes (such as immune responses, senescence, and coagulation). Their use as molecular diagnostics is a growing area. In that regard, EVs can transfer functional cargos (proteins, mRNA, lipids, and essentially any intracellular materials) that may alter the status of recipient cells, thereby contributing to both physiological and pathological processes, and be reflective of the status of the cells from which they have been released. EV size ranges from approximately 30 nm to greater than 1 μm. EVs can be released from any cell and are found in a variety of bodily fluids. EVs can be further divided into exosomes, microvesicles, apoptotic bodies and large oncosomes that can be distinguished by their size and origin. Large oncosomes (1-10 μm) represent a population of EVs that appear to be derived almost exclusively from cancer cells. Apoptotic bodies (50-2,000 nm) arise from cells undergoing programmed cell death (apoptosis) and are thought to function to prevent the release of intracellular contents that may lead to inflammation. However, exosomes (30-120 nm) and microvesicles (MVs; 50-1,000 nm) are released from healthy cells. Exosomes are the smallest of the EVs and arise from the endocytic compartment when multi-vesicular bodies fuse with the plasma membrane and release their vesicular contents. MVs, on the other hand, arise from pinching off of the plasma membrane.

Technical ability to successfully isolate EVs, such as exosomes, from biological fluids (for example, patient's blood, urine, sputum, bronchoalveolar lavage fluid, cerebrospinal fluid, etc.) has considerable impact on scientific discoveries in this rapidly evolving field, and applications in point-of-care testing (POCT) devices for disease diagnosis and management. Currently, the majority of approaches in this space center around a non-proprietary method of ultracentrifugation and a number of commercialized toolkits such as those available from Thermo Fisher Life Technologies (formerly known as Invitrogen), Miltenyi Biotec, 101Bio, System Biosciences, Wako Qiagen, and iZON. The general principles for isolation of exosomes in those kits are precipitation (for example, by mixing the biological sample with polymeric additives to induce precipitation of exosomes), immunoaffinity-based extraction (for example, by utilizing antibody-coated magnetic beads to capture exosomes that contain specific markers) or size-exclusion (for example, by passing through a column with meshed network to capture or release exosomes). Approaches such as ultracentrifugation are laborious and potentially damaging to EVs. Moreover, all these methods (1) can be (very) time-consuming (some taking several hours), (2) exhibit inconsistencies (as they are not semi- or fully automated), (3) require treatment of the biological samples with external reagents—hence, requiring undesired sample manipulation, and/or (4) often have problems with impurities and isolation efficiency. In addition, (5) they are mostly focused on isolating only one subset of EVs (exosomes), whereas EVs encompass multiple categories of vesicles, and (6) none offers the capability to isolate of all EV subsets concurrently.

Given the potential utility of EV isolation tools for clinical diagnostics, a number of microfluidic-based exosome isolation systems and methods have been developed. Such platforms utilize a range of isolation approaches including viscoelastic flow sorting, immunoaffinity-based extraction, membrane-based filtration, trapping on nanowires, acoustic nanofiltration and deterministic lateral displacement. Amongst those approaches, the technologies that are contact-free (that is, label-free) have proved beneficial. However, some drawbacks restrict their broad application. For instance, acoustic-based microfluidics for isolation of nanoparticles isolates particles only in a single pre-determined size bracket (30-200 nm EVs), which is a mixture of exosomes and microvesicles rather than being pure distinct populations of each, and does not extract all EV fractions at the same time. Additionally, that technology suffers from some limitations on wavelength and diffraction that hinder use of the acoustic manipulation. Similarly, membrane-based filtration microfluidic systems typically use pressure or direct current (DC) electrophoresis as an alternative driving force to move particles across filters. However, such systems (1) have a narrow isolation capacity range (3-8,000 μl), (2) can isolate one or at most two (and not all four) EV subgroups at a time, (3) suffer from limited isolation throughput (0.075-36 μL min⁻¹), and (4) may have their filter membranes quickly saturated, as there is no system to remove/collect the captured particles.

Thus, the availability of improved technologies to isolate EVs (and or other entities) based on desired size fractions would be of high value to the field.

### SUMMARY

In one aspect, a system for fractionating multiple fractions of particles from a sample on the basis of particle size includes a fractionation unit which includes a flow conduit or channel divided into two or more compartments by one or more porous membranes of known pore size and a flow module system in fluid connection with the fractionation unit.

The flow module system further includes a sample container for the sample, a backwash container for a backwash fluid, and two or more collection containers for collection of fractionated portions of the sample. Each of the two or more collection containers is in fluid connection with a different one of the compartments. The system further includes a control system in operative connection with the flow module system to control flow of sample to the fractionation unit from the sample container, flow of backwash fluid to the fractionation unit from the backwash container, flow of fractionated portions of the sample from the fractionation unit to each of the two or more collection containers, and optionally (or in some embodiments) flow from collection containers downstream from the first of the one or more membranes to the fractionation unit.

In a number of embodiments, the fractionation unit includes a series of m membranes axially spaced along the length of the flow channel dividing the flow channel into m+1 compartments, wherein m is an integer. Each of the porous membranes has a different pore size, wherein the pore size of the m membranes decreases along the length of the flow channel in the direction of flow of the sample therethrough. The flow module system may, for example, include m+1 collection containers, and the control system may be configured to place each of the m+1 collection containers in fluid connection with a different one of the m+1 compartments.

In a number of embodiments, the control system is configured to deliver the sample from the sample container to a first of the series of m+1 compartments, which is upstream from a first of the porous membranes having the largest pore size, via control of pressure within the sample container and control of an on-off configuration of a sample container valve in fluid connection with an outlet of the sample container and with the first of the series of m+1 compartments. The sample flows through each of the series of m membranes, and fractions of particles in the fluid are excluded from passage through each of the series of m membranes on the basis of particle size. In a number of embodiments, the control system is configured to deliver backwash fluid from the backwash container into each of the m+1 compartments downstream from the first of the porous membranes to backwash each of the m membranes via control of pressure in the backwash container and independent control of an ON-OFF configuration of each of a plurality of backwash valves in fluid connection with an outlet of the backwash container. Each of the plurality of backwash valves is also in fluid connection with a different one of the m+1 compartments downstream from the first of the m porous membranes.

The system may further include m+1 collection valves, wherein each of the m+1 collection valves is in fluid connection with an outlet of a different one of the m+1 collection containers and with a different one of the m+1 compartments. The control system may, for example, be configured to independently control an ON-OFF configuration of each of the m+1 collection valves to place each of the m+1 collection containers in fluid connection with a different one of the m+1 compartments.

The control system may further be configured to independently control pressure within each of the m+1 collection containers. In a number of embodiments, the control system is configured to create a positive pressure within the sample container when the sample is delivered to the fractionation unit and to create a positive pressure within the backwash container when backwash fluid is delivered to the fractionation unit. The control system may be further configured to create a negative pressure in one of the m+1 collection containers when the one of the m+1 collection containers is in fluid connection with an associated one of the m+1 compartments via an ON configuration of the one of the m+1 collection valves in fluid connection with the outlet of the one of the m+1 containers.

The control system may further be configured to allow flow into the one of the m+1 collection containers in fluid connection with the one of the m+1 compartments downstream from the last of the series of m membranes during delivery of the sample to the fractionation unit. In a number of embodiments, the control system is further configured to cause backwash fluid to be delivered to each of the m+1 compartments downstream from the first of the m porous membranes sequentially after flow of the sample to the fractionation unit is stopped and to allow flow into the one of the m+1 collection containers in fluid connection with the one of the m+1 compartments upstream from the one of the m+1 compartments into which backwash fluid is being delivered. In a number of embodiments, the control system is configured to first cause backwash fluid to be delivered to the one of the m+1 compartments downstream of the last of the series of m membranes and then sequentially deliver backwash fluid to each of other m+1 compartments downstream from the first of the m+1 compartments, proceeding from downstream to upstream.

In a number of embodiments, the control system is configured to allow flow into the one of the m+1 collection containers in fluid connection with the one of the m+1 compartments downstream from the first of the series of m membranes during delivery of the sample to the fractionation unit. The control system may, for example, be configured to allow flow between any two of the m+1 collection containers that are in fluid connection with adjacent ones of the m+1 compartments downstream from the first of the series of in membranes. In a number of embodiments, the control system is configured to create a positive pressure in the upstream one of the two of the m+1 collection containers and to create a negative pressure in the downstream one of the two of the m+1 collection containers to cause flow from the upstream one of the two of the m+1 collection containers to the downstream one of the two of the m+1 containers. Such a mode of operation allows for passage of sample across a single membrane at a time, providing more precise user control of individual membrane flux in any iterations of the fractionation unit containing m membranes wherein m is greater than 1.

In a number of embodiments, the control system includes a processor system in operative connection with a memory system. The memory system has one or more algorithms stored therein and executable by the processor system to control flow (including, for example, flow direction and flow rate) of sample to the fractionation unit from the sample container, flow (including, for example, flow direction and flow rate) of backwash fluid to the fractionation unit from the backwash container, and flow of fractionated portions of the sample from the fractionation unit to each of the two or more collection containers. In a number of embodiments, the one or more algorithms are further executable by the processor system to control flow from collection containers downstream from the first in the series of membranes to the fractionation unit. The control system may, for example, control flow of sample to the fractionation unit from the sample container, flow of backwash fluid to the fractionation unit from the backwash container, flow of fractionated portions of the sample from the fractionation unit to each of the two or more collection containers, and optionally flow from collection containers downstream from the first in the series of membranes to the fractionation unit, pneumatically.

In a number of embodiments, the sample container is a barrel of a sample syringe, the backwash container is a barrel of a backwash syringe, and each of the m+1 collection containers is a barrel of m+1 collection syringes.

The membranes hereof may be sized (that is, with different pore size ranges) to achieve virtually any fractionation. In a number of embodiments, the m membranes are sized to fractionate particles in the range of 1 nm to 100 μm or in the range of 5 nm to 50 μm. The m membranes may, for example, be sized to fractionate differently sized extracellular vesicles or differently sized cells. In a number of embodiments, the control system is configured to achieve microfluidic control through the fractionating unit.

Data of state values may, for example, be input to the control system to control flow of sample to the fractionation unit from the sample container, flow of backwash fluid to the fractionation unit from the backwash container, flow of fractionated portions of the sample from the fractionation unit to each of the two or more collection containers, and optionally flow from collection containers downstream from the first in the series of membranes to the fractionation unit, automatically.

In a number of embodiments, the fractionation unit includes m+1 blocks of material, wherein each of the blocks of material includes a passage therethrough. The blocks of material are stacked so that the passage of each block of material aligns with (that is, placed in fluid connection with—through an intervening membrane as further discussed below) the passage of an adjacent block or blocks of material to form the flow channel. One of the m membranes is positioned between each adjacent block of material so that the m membranes are axially spaced by the blocks of material along the length of the flow channel dividing the flow channel into m+1 compartments.

The fractionation unit may further include a first clamp member which is in abutting contact with the stacked blocks of material on one axial end of the flow channel and a second clamp member which is in abutting contact with the stacked block of material at another axial end of the flow channel. The first clamp member and the second clamp member are configured to apply a compressive force to the stacked blocks of material to create a seal between adjacent blocks of material of the stacked blocks of material.

In another aspect, a method for fractionating multiple fractions of particles from a sample on the basis of particle size includes providing a fractionation unit which includes a flow channel divided into two or more compartments by one or more porous membranes of known pore size and providing a flow module system in fluid connection with the fractionation unit. The flow module system includes a sample container for the sample, a backwash container for a backwash fluid, and two or more collection containers for collection of fractionated portions of the sample. Each of the two or more collection containers is in fluid connection with a different one of the compartments. The method further includes controlling, via a control system in operative connection with the flow module system, flow of sample to the fractionation unit from the sample container, flow of backwash fluid to the fractionation unit from the backwash container, and flow of fractionated portions of the sample from the fractionation unit to each of the two or more collection containers. In a number of embodiments, the method further includes controlling, via the control system, flow from collection containers downstream from the first of the one or more membranes to the fractionation unit.

As described above, in a number of embodiments, the fractionation unit includes a series of m membranes axially spaced along the length of the flow channel dividing the flow channel into m+1 compartments, wherein m is an integer. Each of the porous membranes has a different pore size, wherein the pore size of the m membranes decreases along the length of the flow channel in the direction of flow of the sample therethrough. The flow module system may, for example, include m+1 collection containers, and the control system may be configured to place each of the m+1 collection containers in fluid connection with a different one of the m+1 compartments.

In a number of embodiments, the control system is configured to deliver the sample from the sample container to a first of the series of m+1 compartments, which is upstream from a first of the porous membranes having the largest pore size, via control of pressure within the sample container and control of an on-off configuration of a sample container valve in fluid connection with an outlet of the sample container and with the first of the series of m+1 compartments so that a fluid of the sample flows through each of the series of m membranes and fractions of particles in the fluid are excluded from passage through each of the series of m membranes on the basis of particle size. In a number of embodiments, the control system is configured to deliver backwash fluid from the backwash container into each of the m+1 compartments downstream from the first of the porous membranes to backwash each of the m membranes via control of pressure in the backwash container and independent control of an ON-OFF configuration of each of a plurality of backwash valves in fluid connection with an outlet of the backwash container. Each of the plurality of backwash valves is also in fluid connection with a different one of the m+1 compartments downstream from the first of the m porous membranes.

The system may further include m+1 collection valves, wherein each of the m+1 collection valves is in fluid connection with an outlet of a different one of the m+1 collection containers and with a different one of the m+1 compartments. The control system may, for example, be configured to independently control an ON-OFF configuration of each of the m+1 collection valves to place each of the m+1 collection containers in fluid connection with a different one of the m+1 compartments.

The control system may further be configured to independently control pressure within each of the m+1 collection containers. In a number of embodiments, the control system is configured to create a positive pressure within the sample container when the sample is delivered to the fractionation unit and to create a positive pressure within the backwash container when backwash fluid is delivered to fractionation unit. The control system may be further configured to create a negative pressure in one of the m+1 collection containers when the one of the m+1 collection containers is in fluid connection with an associated one of the m+1 compartments via an ON configuration of the one of the m+1 collection valves in fluid connection with the outlet of the one of the m+1 containers.

The control system may further be configured to allow flow into the one of the m+1 collection containers in fluid connection with the one of the m+1 compartments downstream from the last of the series of m membranes during delivery of the sample to the fractionation unit. In a number of embodiments, the control system is further configured to cause backwash fluid to be delivered to each of the m+1 compartments downstream from the first of the m porous membranes sequentially after flow of the sample to the fractionation unit is stopped and to allow flow into the one of the m+1 collection containers in fluid connection with the one of the m+1 compartments upstream from the one of the m+1 compartments into which backwash fluid is being delivered. In a number of embodiments, the control system is configured to first cause backwash fluid to be delivered to the one of the m+1 compartments downstream of the last of the series of m membranes and then sequentially deliver backwash fluid to each of other m+1 compartments downstream from the first of the m+1 compartments, proceeding from downstream to upstream.

As described above, in a number of embodiments, the control system is configured to allow flow into the one of the m+1 collection containers in fluid connection with the one of the m+1 compartments downstream from the first of the series of m membranes during delivery of the sample to the fractionation unit. The control system may, for example, be configured to allow flow between any two of the m+1 collection containers that are in fluid connection with adjacent ones of the m+1 compartments downstream from the first of the series of m membranes. In a number of embodiments, the control system is configured to create a positive pressure in the upstream one of the two of the m+1 collection containers and to create a negative pressure in the downstream one of the two of the m+1 collection containers to cause flow from the upstream one of the two of the m+1 collection containers. Such a mode of operation, allows for passage of sample across a single membrane at a time, providing more precise user control of individual membrane flux in any iterations of the fractionation unit containing m membranes wherein m is greater than 1.

In a number of embodiments, the control system includes a processor system in operative connection with a memory system. The memory system has one or more algorithms stored therein and executable by the processor system to control flow of sample to the fractionation unit from the sample container, flow of backwash fluid to the fractionation unit from the backwash container, and flow of fractionated portions of the sample from the fractionation unit to each of the two or more collection containers. In a number of embodiments, the one or more algorithms are further executable by the processor system to control flow from collection containers downstream from the first in the series of membranes to the fractionation unit. The control system may, for example, control flow of sample to the fractionation unit from the sample container, flow of backwash fluid to the fractionation unit from the backwash container, flow of fractionated portions of the sample from the fractionation unit to each of the two or more collection containers, and optionally flow from collection containers downstream from the first in the series of membranes to the fractionation unit, pneumatically.

In a number of embodiments, the sample container is a barrel of a sample syringe, the backwash container is a barrel of a backwash syringe, and each of the m+1 collection containers is a barrel of m+1 collection syringes.

As further described above, in a number of embodiments, the m membranes are sized to fractionate particles in the range of 1 nm to 100 μm or in the range of 5 nm to 50 μm. The m membranes are, for example, sized to fractionate differently sized extracellular vesicles or differently sized cells. In a number of embodiments, the control system is configured to achieve microfluidic control through the fractionating unit.

Data of state values may, for example, be input to the control system to control flow of sample to the fractionation unit from the sample container, flow of backwash fluid to the fractionation unit from the backwash container, flow of fractionated portions of the sample from the fractionation unit to each of the two or more collection containers, and optionally flow from collection containers downstream from the first in the series of membranes to the fractionation unit, automatically.

In a number of embodiments, the fractionation unit includes m+1 blocks of material, wherein each of the blocks of material includes a passage therethrough. The blocks of material are stacked so that the passage of each block of material aligns with the passage of an adjacent block or blocks of material to form the flow channel. One of the m membranes is positioned between each adjacent block of material so that the m membranes are axially spaced by the blocks of material along the length of the flow channel dividing the flow channel into m+1 compartments.

The fractionation unit may further include a first clamp member which is in abutting contact with the stacked blocks of material on one axial end of the flow channel and a second clamp member which is in abutting contact with the stacked block of material at another axial end of the flow channel. The first clamp member and the second clamp member are configured to apply a compressive force to the stacked blocks of material to create a seal between adjacent block of material of the stacked blocks of material.

In a further aspect, a fractionation unit includes a series of m membranes axially spaced along the length of a flow channel dividing the flow channel into m+1 compartments. Each of the porous membranes has a different pore size, wherein the pore size of the m membranes decreases along the length of the flow channel in the direction of flow of a sample therethrough. As described above, in is an integer.

In a number of embodiments, the fractionation unit includes m+1 blocks of material. Each of the blocks of material includes a passage therethrough, and the blocks of material are stacked so that the passage of each block of material aligns with the passage of an adjacent block or blocks of material to form the flow channel. One of the m membranes is positioned between each adjacent block of material so that the m membranes are axially spaced by the blocks of material along the length of the flow channel dividing the flow channel into m+1 compartments.

In a number of embodiments, the fractionation unit further includes a first clamp member which is in abutting contact with the stacked blocks of material on one axial end of the flow channel and a second clamp member which is in abutting contact with the stacked block of material at another axial end of the flow channel. The first clamp member and the second clamp member may be configured to apply a compressive force to the stacked blocks of material to create a seal between adjacent block of material of the stacked blocks of material.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates an isometric view of a system hereof including a control system, a flow module system, and a multi-fractionation system.

FIG. 1B illustrates a schematic diagram of the system of FIG. 1A.

FIG. 1C illustrates a schematic diagram of another embodiment of a system hereof.

FIG. 1D illustrates a schematic diagram for an embodiment of a methodology hereof for use of the system of FIG. 1C to separate a representative sample into three fractions.

FIG. 2 illustrates an isometric view of the control system of FIG. 1A.

FIG. 3A illustrates an isometric view of one of the housing units of the flow module system of FIG. 1A in which three collection modules C2 through C4 are positioned.

FIG. 3B illustrates an isometric view of another one of the housing units of the flow module system of FIG. 1A in which three modules are positioned including collection module C1, sample module 210, and backwash module 210′.

FIG. 3C illustrates an enlarged, isometric exploded view of collection module C7.

FIG. 4A illustrates an isometric, hidden-line exploded view of the multi-fractionation system of FIG. 1A.

FIG. 4B illustrates an isometric exploded view of the multi-fractionation system or unit of FIG. 1A.

FIG. 4C illustrates an isometric view of the multi-fractionation system or unit of FIG. 1A.

FIG. 4D illustrates a top, hidden-line view of the multi-fractionation device of the multi-fractionation system of FIG. 1A.

FIG. 4E illustrates an isometric, hidden-line view of the multi-fractionation device.

FIG. 4F illustrates a side, hidden-line view of the multi-fractionation device.

FIG. 5 illustrates schematically an embodiment of a system hereof for contemporaneous or single-run separation or fractionation of four size ranges of extracellular vesicles or EVs under software-based control.

FIG. 6A illustrates the results of a representative separation of 100 nm particles from a fluid sample using a representative embodiment of a system hereof for several experimental runs represented by different line types.

FIG. 6B illustrates the results of a representative separation of 200 nm particles from a fluid sample using a representative embodiment of a system hereof for several experimental runs represented by different line types.

### DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or“in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a module” includes a plurality of such modules and equivalents thereof known to those skilled in the art, and so forth, and reference to “the module” is a reference to one or more such modules and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

The terms “electronic circuitry”, “circuitry” or “circuit,” as used herein include, but are not limited to, hardware, firmware, software, or combinations of each to perform a function(s) or an action(s). For example, based on a desired feature or need, a circuit may include a software-controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “controller,” as used herein includes, but is not limited to, any circuit or device that coordinates and controls the operation of one or more input and/or output devices. A controller may, for example, include a device having one or more processors, microprocessors, or central processing units capable of being programmed to perform functions.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

Devices, systems, and methods hereof decrease or eliminate many of the technical limitations associated with currently available separation or fractionation systems, and particularly those used for the separation of biological entities based upon size such as EVs and cells. In a number of embodiments, a Hierarchically Structured Microfluidic Fractionation Device (sometimes referred to herein as ‘HIMISFRA’) for concurrent or single-run unlabeled isolation of EVs and cells (HIMISFRA-EV and HIMISFRA-Cell) is described herein. As used herein, the terms “microfluidic” and “microfluidic control” (and typically precise control) refer to the manipulation of relatively small volumes of fluids through flow channels at the submillimeter scale. Although embodiments of the present invention are discussed in connection with size-exclusion separation of biological entities such as EVs and cells over a particular ranges of EV/cell size in microfluidic flow, the devices, systems, and method hereof may readily be scaled to effect separations of mixture of virtually any particles based on size exclusion (over a broad range of particle size) using a range of flow volumes and flow channels which may extend well outside the realm of microfluidics.

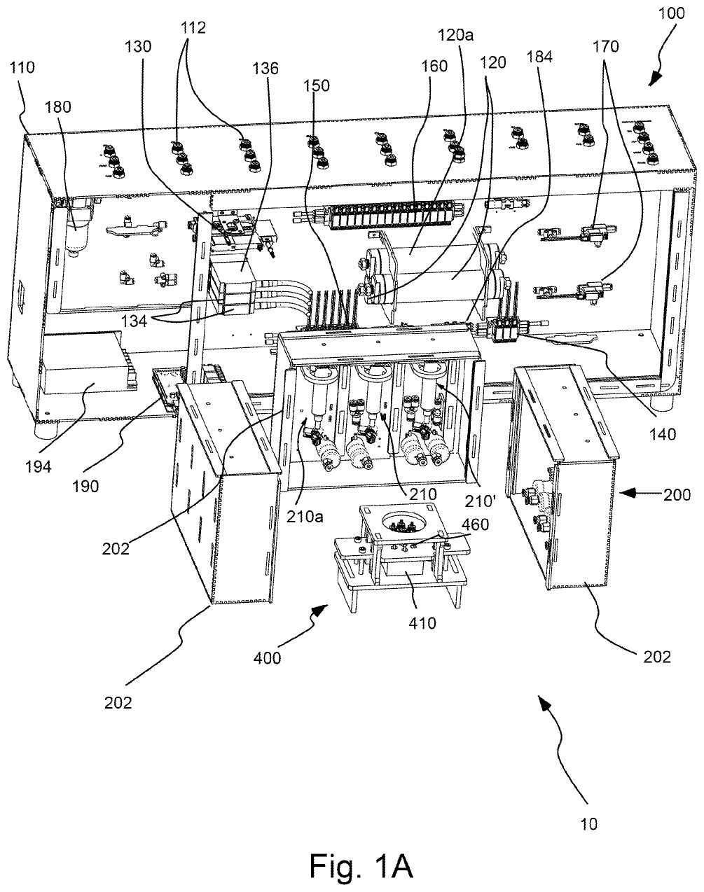

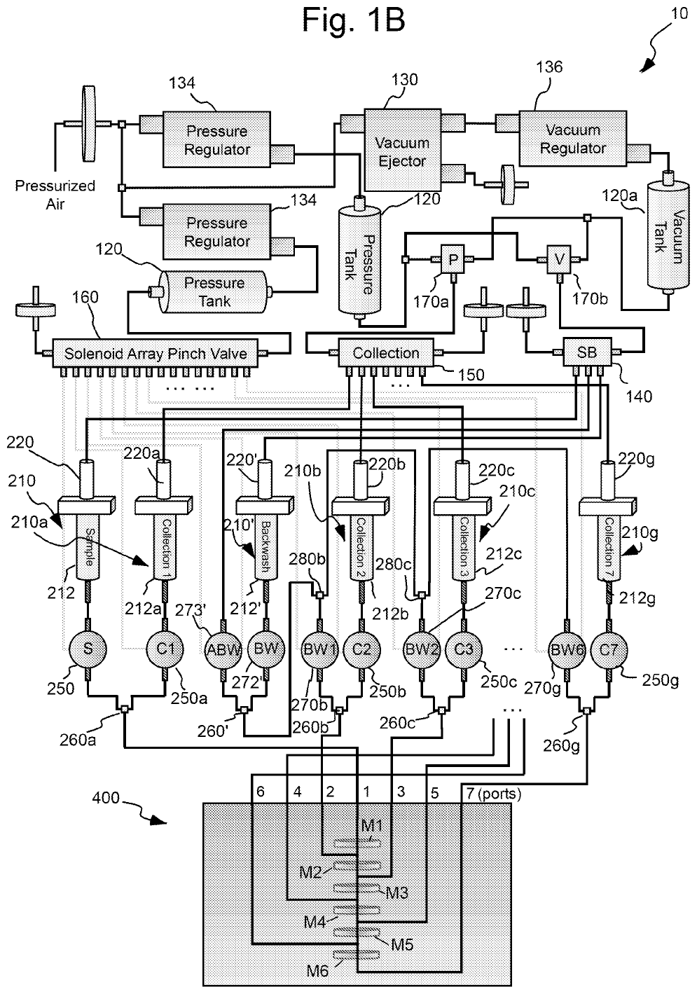

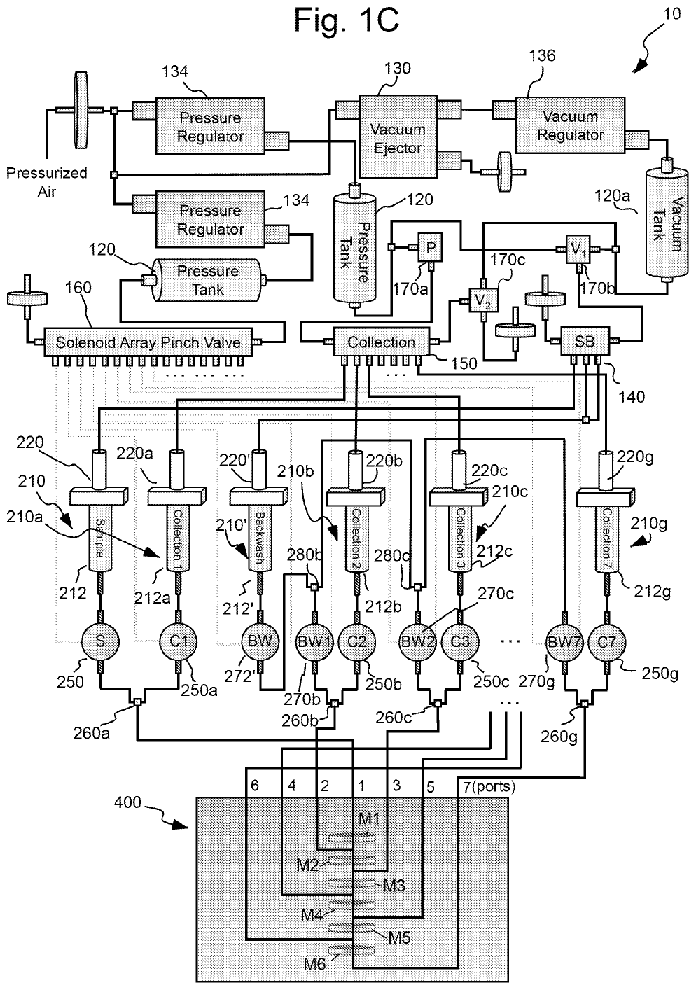

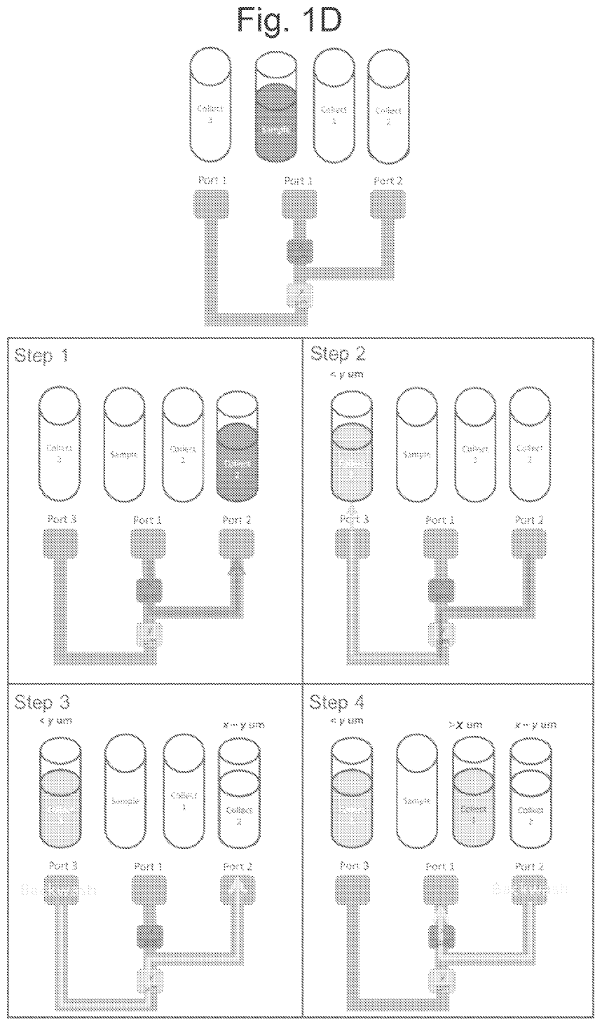

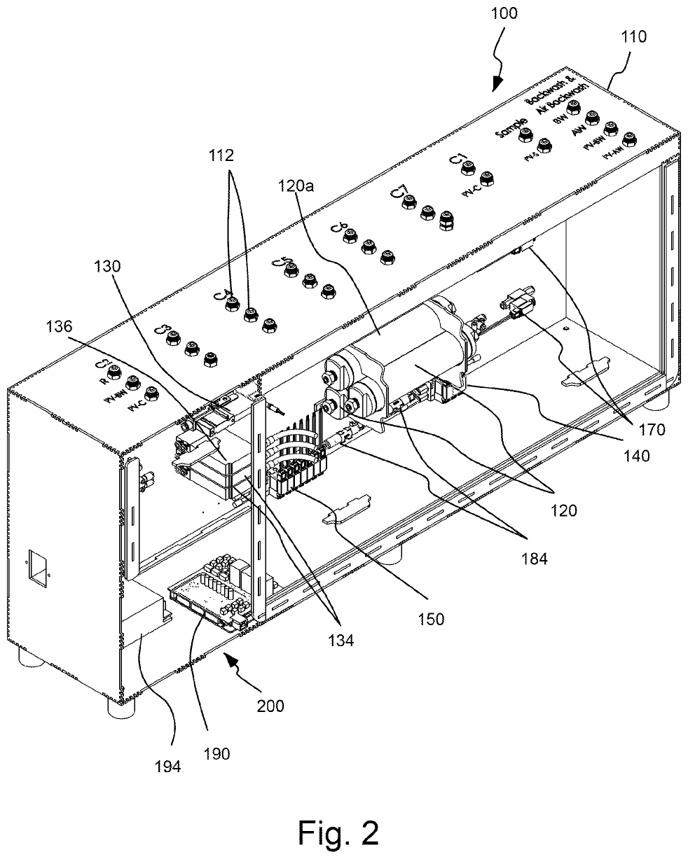

A representative embodiment of a system (HIMISFRA) 10 hereof is illustrated in FIG. 1A. In the illustrated embodiment, system 10 includes a control system or center 100 for control of both pneumatics and electronics. Control system 100 pneumatically controls the flow of liquid through various modules in system 10. In that regard, in the illustrated embodiment, system 10 includes a flow module system 200 including a sample module S, a backwash module BW, and a plurality of collection modules C1 through Cn (C1 through C7 in the illustrated embodiment). In FIG. 1A, conduits or tubing for pneumatic and liquid/fluid connections are not shown for clarity and simplicity in the drawings. Such connections are represented in the schematic diagram of FIGS. 1B and 1C. Furthermore, system 10 includes a fractionation unit 400, which in the illustrated embodiment, is a microfluidic multi-fractionating unit. A representative embodiment of control system 100 is illustrated in FIGS. 1A and 2). Control system 100 controls pressure and vacuum (that is, pressure that may be positive, negative, or atmospheric) delivered to the sample module S, backwash module BW and collection modules C1 through C7 in the illustrated embodiment. Further, control system 100 also controls actuation of pneumatic flow control components such as the pneumatic pinch valves (which may, for example, be actuated via electromechanically operated solenoids) described further below.

Control system 100 includes a housing 110 and stores pressurized gas (for example, air) in tanks 120, which can be pressurized from an external source. In the illustrated embodiment, two pressurized gas storage tanks 120 are provided. Control system 100 regulates air pressure as well as generating regulated vacuum pressure. In the illustrated embodiment, vacuum is generated via a vacuum pump such as a vacuum ejector 130 and regulated via pressure regulators 134 and vacuum regulator 136. Air pressure and vacuum pressure are thus stored/created independently in individual tanks 120 and 120a, respectively. Tanks 120 and 120a are multiplexed through three sets of solenoid valve arrays. In the illustrated embodiment, the solenoid arrays are divided to control: (1) sample and backwash modules S and BW, respectively, via solenoid array 140, (2) collection modules C1 through C7 via solenoid array 150, and (3) pneumatic pinch valves via solenoid array 160. In the embodiment of FIG. 1B, positive and negative select solenoids 170a and 170b, respectively, are provided. FIG. 1C illustrates an alternative embodiment in which positive, negative, and atmospheric pressure select solenoids 170a, 170b and 170c, respectively, are provided. In the embodiment of FIG. 1C, one or more of collection modules C1 through C7 can access positive pressure or negative pressure (vacuum) independently. Control system 100 further includes a main filter 180 and one or more smaller filters 184 to remove particulates and humidity form the air that enters control system 100. Control system 100 also includes a range of tubing adapters/connectors 112 (see, for example, FIG. 2 in which adapters/connectors are labeled) and other adaptors/connectors for connecting the pneumatics and electronics to a flow module system 200 including sample module S, backwash module BW, and collection modules C1 through C7.

Control system 100 further includes electronic circuitry 190 which includes an electronic controller which may, for example, be formed on one or more printed circuit boards (as known in the electronics arts) in operative connection with a power supply 194 (for example, a power supply connectible to system power via a wire and/or a battery system).

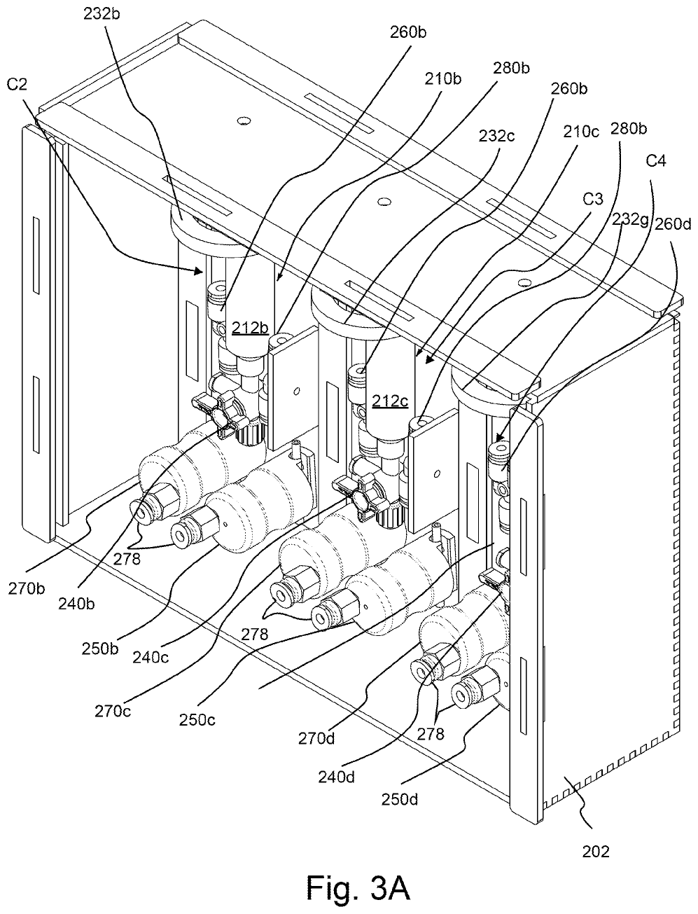

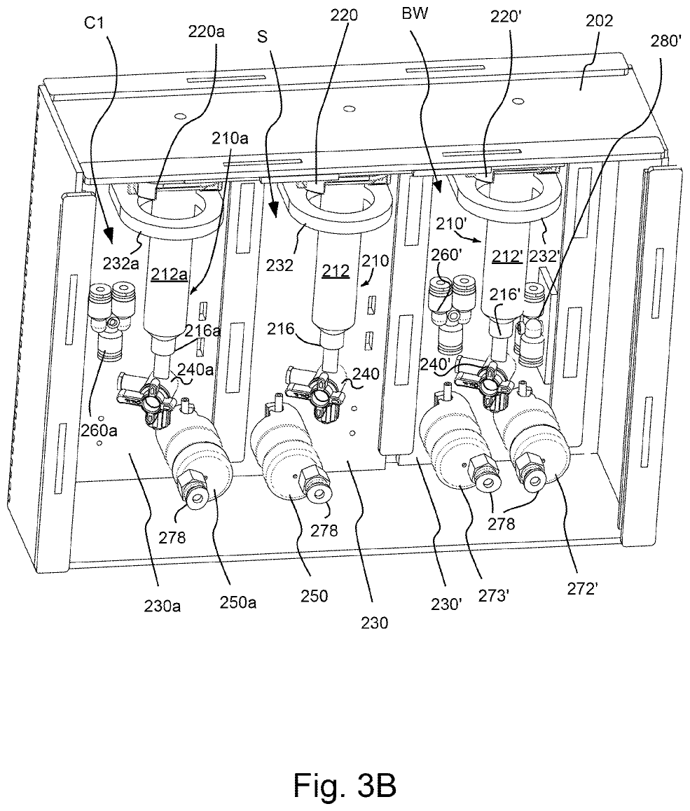

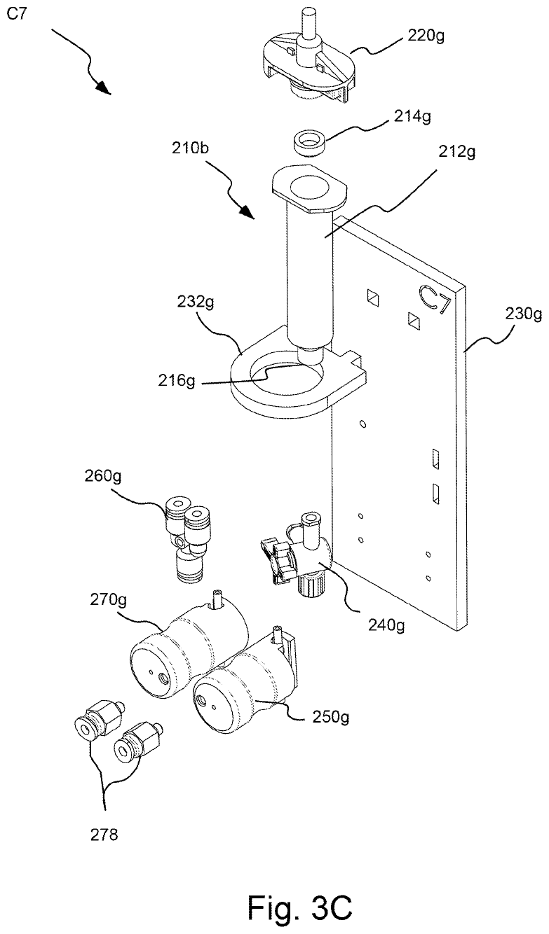

In the illustrated embodiment, a sample, backwash, and collection module set/system 200 (see FIGS. 1A and 3A through 3C) includes nine modules (each with a dedicated reservoir) grouped into three groups of three. Sample module S, is used for loading the biological liquid or sample. Backwash module BW, is used for containing and delivering a backwash fluid such as a buffer or culture medium to run through system 10. The remaining seven modules are referred to herein as collection modules C1 through C7. Collection modules C1 through C7 collect particles captured on each membrane as well as the smallest particles passing through the lowest membrane pore size. Collection module 1 or C1 collects the largest particles, while collection module 7 or C7 collects the smallest particles. Collection modules C2-C6 can also act as intermediary modules for performing sequential steps of single membrane filtration. In such an embodiment, the intermediary module fills with a partially fractionated sample before distributing it through the next membrane as described further below.

Referring for example to FIGS. 1B and 3A through 3C, the overall design principle of each module or module system 200 in the illustrated embodiment is that of a pneumatic-powered/controlled syringe. As illustrated in, for example, FIGS. 1B and 3C, for the representative example of collection module C7, syringe 210g includes a syringe container or reservoir 212g, which is held tightly to a support 230g by an acrylic bracket 232g. Brackets 232g may, for example, be attached to housing units 202 as illustrated in FIGS. 1A, 3A and 3B. In the illustrated embodiment, three modules are positioned in each housing unit 202. A pneumatically-controlled piston or plunger 214g, which forms a seal with the interior wall of reservoir 212g, is reciprocally slidable within reservoir 230g. As known in the syringe arts, movement of piston 214g toward an outlet 216g of syringe (for example, under positive pneumatic pressure) causes ejection of fluid from outlet 216, while movement of piston 214g away from outlet 216g (for example, under negative pressure/vacuum) causes fluid to be drawn into reservoir 212g. Syringe 210g further includes a pneumatic adapter 220g via which syringe reservoir 212g and piston 214g are placed in pneumatic connection with solenoid array 150. Each of syringes 210a through 210g of collections modules C1 through C7 are constructed in the same or a similar manner, and corresponding elements are numbered similarly using the designations “a” through “g” at the end of each reference number for collections modules C1 through C7, respectively. Each of pneumatic adaptors 220a through 220g is placed in pneumatic connection with solenoid array 150 as described for syringe 210g of control module C7. Syringe 210 of sample module S and syringe 210′ of backwash module BW are also constructed in the same or a similar manner, and corresponding elements are numbered similarly using the designation “′” after the numeral in the case of syringe 210′ of backwash module BW and no further designation after the reference numeral in the case of syringe 210 of sample module S. Pneumatic adaptors 220 and 220′ of sample module S and backwash module BW are placed in pneumatic connection with solenoid array 140 as described above.

Referring again to FIG. 3C, outlet 216g of syringe reservoir 212g connects to a 3-way valve 240g. Each of outlets 216a-g of syringes 210a-g of control modules C1 through C7 connect to a 3-way valve 240a-g, respectively, in the illustrated embodiment. Similarly, outlets 216 and 216′ of syringes 210g and 210′ of sample module S and backwash module BW connect to a 3-way valve 240 and 240′, respectively, in the illustrated embodiment. The inclusion of such 3-way vales makes it easier for a user to extract the collected fractions from the collection modules C1 through C7 as well as to load the sample into sample module S and to load buffer into backwash module BW.

In the illustrated embodiment, each of 3-way valves 216a-g of collection modules C1 through C7 connects to a port in a multi-compartmentalized microfluidic unit or device (described further below) via a collection valve such as a pneumatic pinch valve 250a-g as illustrated, for example, in FIG. 1B. In the case of control modules C2 through C7 pinch valves 250b-g connect to ports 2 through 7, respectively, via y-adaptors 260b-g. One port of y-adaptors 260b-g is in fluid connection with 3-way valves 216b-g and another port is in fluid connection with pneumatic pinch valves 270b-g. Pneumatic pinch valves 270b-g (backwash valves) are each in fluid connection with syringe 210′ of backwash module BW via a pneumatic pinch valve 272′ in fluid connection with 3-way valve 240′. In the embodiment illustrated in FIG. 1B, pneumatic pinch valve 272′ is in fluid connection with pneumatic pinch valves 270b-g via y-connectors 280b-f(see, for example, FIG. 1B) in a serial or daisy chain arrangement. In an alternative embodiment, backwash module BW may include a y-connector 280′ (see FIG. 3B) via which valves 270b-d can be connected via one series and valves 270e-g may be connected via a separate series to pneumatic pinch valve 272′. In the illustrated embodiment, backwash module BW further includes a pneumatic pinch valve 273′ to achieve an air backwash (ABW) in which pressurized air is introduced through the system at the end of a run to flush out backwash solution remaining within fractionation unit 400 and all fluid connections. The pneumatic pinch valves hereof are, for example, placed in connection with control system 100 via pneumatic adaptors 278 as illustrated, for example, in FIG. 3C.

Unlike syringes 210a-g of collection modules C2 through C7, syringe 210′ of backwash module BW is connected to only a single pneumatic pinch valve (a backwash valve) because it is connected to only pneumatic pinch valves 270b-g and not directly to multi-fractionation unit 400. Similarly, syringe 210 of sample module S is connected to only a single pneumatic pinch valve 250 (a sample valve) because it is connected only to port 1 of multi-fractionation unit 400. Likewise, collection module C1 is connected to only a single pneumatic pinch valve 250a because collection module C1 is connected only to port 1 of multi-fractionation unit 400. In the illustrated embodiment, pneumatic pinch valves 250 and 250a are connected to port 1 (that is, the port upstream of the first membrane M1) via a y-connector 260.

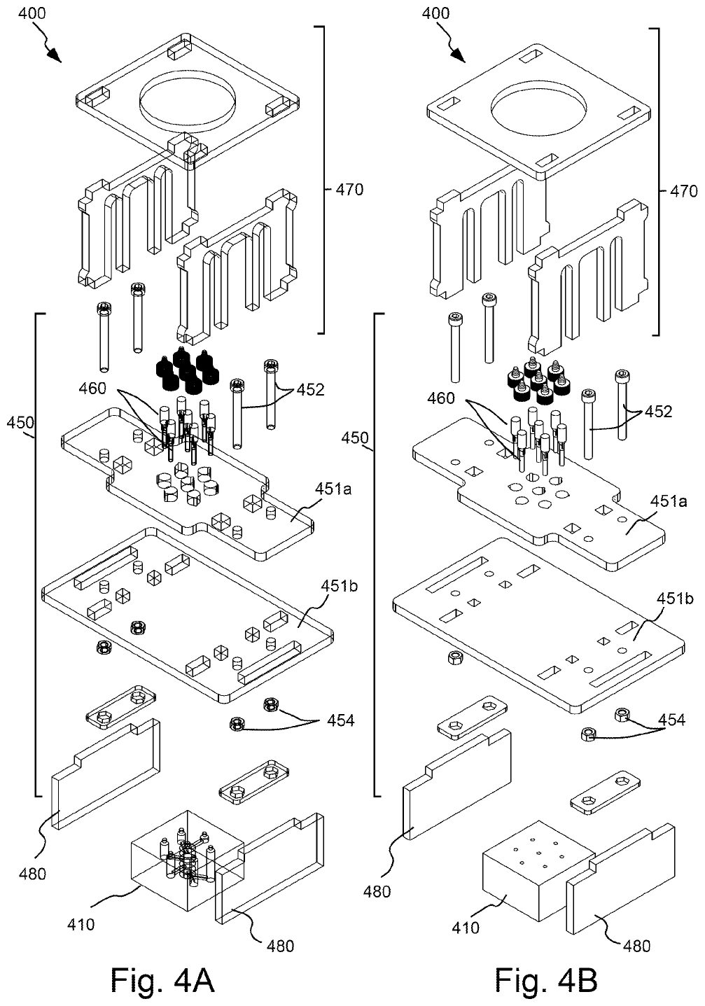

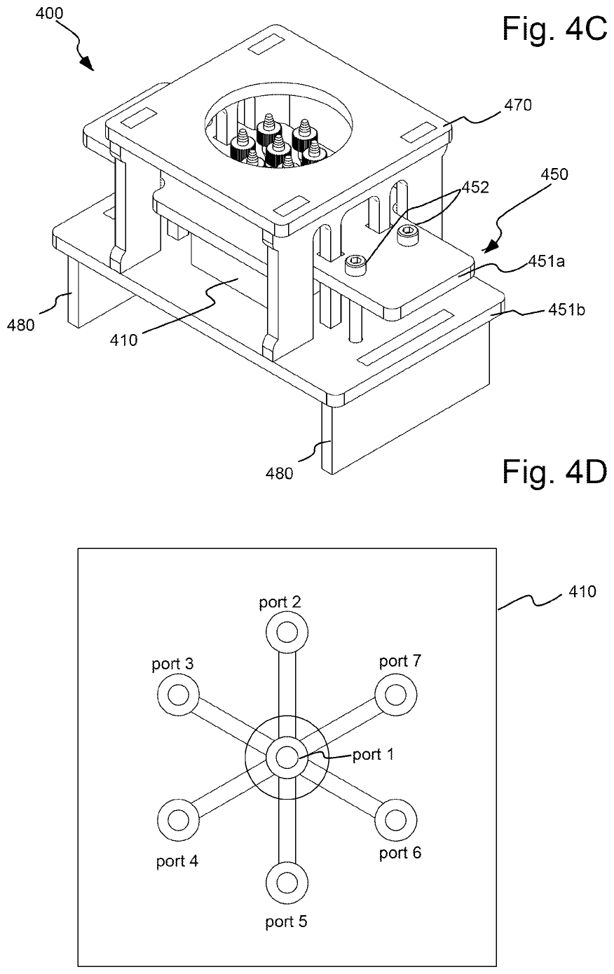

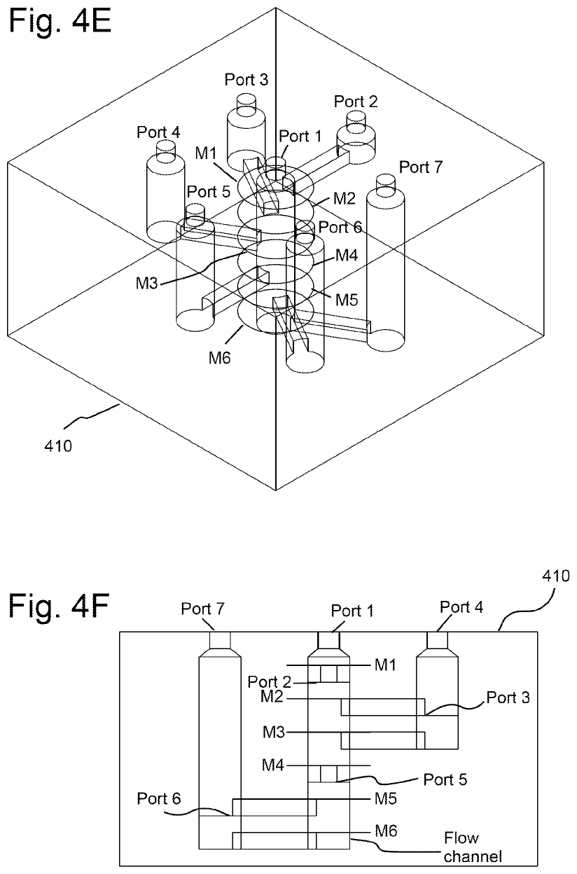

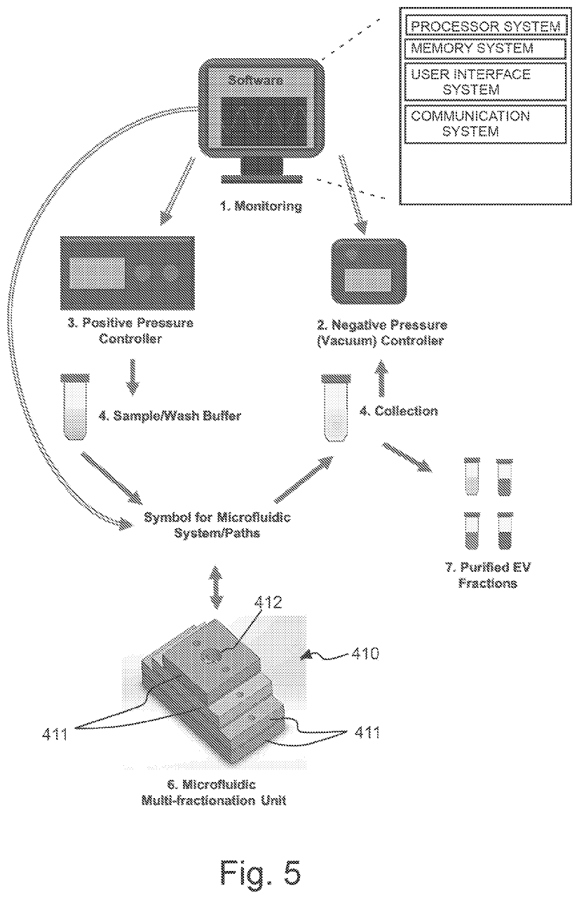

Multi-fractionation system or unit 400, which is illustrated in FIGS. 1A, 1B, 4A through 4F, and 5 includes a multi-compartmentalized microfluidic device 410 and was formed from blocks, layers, or slabs 411 (see FIG. 5) of a polymeric material (for example, a polydimethylsiloxane (PDMS)-based material) which were compressed mechanically by an outer custom-designed clamp 450 (for example, formed from a polymeric material such as an acrylic material). Each of blocks 411 includes a passage 412 therethrough which align to form the flow channel (see FIG. 4F) through fractionation unit 400. Clamp 450 includes a first abutment/clamp member 451a and a second abutment/clamp member 451b which compress device 410 therebetween. Clamp 450 further holds the needles 460 that connect to ports 1 through n (1 through 7 in the illustrated embodiment) of device 410. Clamp 450 includes connectors (for example, bolts 452 and cooperating nuts 454) in the illustrated embodiment that are tightened to apply the necessary force (via first clamp member 451a and second clamp member 451b) to non-chemically seal device 410. In the illustrated embodiment, device 400 further includes a housing 470 which at least partially encompasses and protects needles 460 (and which attaches to clamp 450) and lower support members 480 (which also attach to clamp 450).

In the illustrated embodiment, device 410 houses six membranes M1 through M6 (see, for example, FIG. 1B) of varying pore sizes (100 nm, 200 nm, 500 nm, 1 μm, 5 μm and 10 μm in a studied representative embodiment) sandwiched between the PDMS blocks, layers, or slabs 411 of device 410. As clear to those skilled in the art, the number of PDMS layers (and the corresponding number of membranes and membrane compartments) as well as the pore sizes of the membranes may be readily altered to achieve various user-defined or user-chosen contemporaneous separations as described herein. As illustrated, for example, in FIG. 4F, six membranes M1 through M6 divide a flow channel passing through device 410 into seven compartments. In the illustrated embodiment, the largest pore size membrane M1 is positioned at the top of device 410 (in reference to the illustrated orientation; in other words, upstream of all other membranes) and the smallest size membrane M6 is positioned at the bottom (in reference to the illustrated orientation; in other words, downstream of all other membranes). A radially central and axially-oriented (with reference to the flow channel) port 1 is connected to sample module S and collection module C1. Radially oriented ports 2 through 7 are connected to collection modules C2 through C7, respectively. In general, a number of axially spaced membranes m will separate the flow channel into m+1 compartments. Accordingly, m+1 collection modules may be connected to ports exiting such compartments to provide separation into m+1 fractions.

In the embodiment FIG. 1B, when control system 100 of system 10 initiates a run, the sample fluid flows from syringe 210 into device 410 through port 1 and exits device 410 via port 7 in the illustrated embodiment. Along this passage through device 410, particles of the sample are deposited above each membrane M1 through M6 within membrane compartments. The particles smaller than the pores of the bottommost membrane M6 will exit via port 7 and be collected in collection module C7. After every volume/time-defined sample run process, a series of backwashes occurs starting with the backwash fluid being injected into device 410 via port 7 (via control of the backwash module BW and pneumatic pinch valve 270g) and leaving device 410 via port 6 to be collected in collection module C6. As this occurs, the backwash fluid collects the particles captured on the bottommost membrane M6. A similar set of backwashes are repeated for each membrane compartment, working from smallest to the largest membrane pore sizes (bottom-to-top in the illustrated orientation).

When processing the sample through fractionation unit 400, positive pressure is applied to piston 214 of syringe 210 via pneumatic adaptor 220 and negative pressure is applied to piston 214g of syringe 210g via pneumatic adaptor 220g (via the vacuum system of control system 100). During the introduction of the sample to port 1 of fractionation unit 400, only pneumatic pinch valves 250 and 250g are in an ON/open state. Subsequently a backwash phase begins, starting with backwash through membrane M6 (see, FIG. 4F) and into syringe 210f of collection module C6. In backwash through membrane M6, positive pressure is applied to piston 214′ of syringe 210′ via pneumatic adaptor 220′ and negative pressure is applied to piston 214f of syringe 210f via pneumatic adaptor 220f. During backwash through membrane M6, pneumatic pinch valves 272′, 270g, and 250f are open to introduce backwash fluid (for example, saline/buffer) into port 7 and remove fluid through port 6. The backwash process then repeats for each of collection modules C5 through C1 in descending order (that is, into syringes 210e, 210d, 210c, 210b, and then 210a). During backwash into each collection module, positive pressure is applied to syringe 210′ via pneumatic adaptor 220′ and pneumatic pinch valve 272′ remains open. In a number of embodiments, after each backwash into a collection module, pneumatic pinch valve 272′ is closed and pneumatic pinch valve 273′ is opened to introduce pressurized air to the system to remove fluid in all connection conduits/tubes and from fractionation unit 400 in an “air backwash” procedure. The final fluid backwash in the backwash phase is into syringe 210a of collection module C1. In a number of embodiments, during the final backwash, positive pressure is applied to piston 214′ of syringe 210′ via pneumatic adaptor 220′ and negative pressure is applied to piston 210a of syringe 210a via pneumatic adaptor 220a (wherein pneumatic pinch valves 272′, 270b, and 250a are in an ON/open state).

Thus, in the mode of operation enabled by the embodiment of FIG. 1B in the use of system 10 for separation of more than two particle fractions, the sample may be passed through the series of membranes in a single step (via positive pressure into the sample container and vacuum into the collection container downstream of the last membrane of the series). Because each membrane in the series of membranes introduces flow resistance, it may be beneficial to allow a mode of operation in which the process involves a series of steps so that the transmembrane pressure and flux across each membrane can be better controlled. Such a process is, for example, enabled by the embodiment illustrated in FIG. 1C in which positive pressure can be applied to collection modules. Positive pressure can be accessed by/applied to collection modules in the embodiment of FIG. 1B. In the embodiment of FIG. 1C, however, two or more collection containers can independently access positive or negative pressure at the same time. In the embodiment of FIG. 1C, pneumatic pinch valve 273′ and y-connector 260′ are absent.

In a representative example of such an alternative process for separation of three fractions (see FIG. 1D), positive pressure is first introduced into the sample container/syringe 212, and negative pressure/vacuum is introduced into syringe 212b of collection module C2, which is connected to the membrane compartment immediately downstream of first membrane M1 of the series m membranes. If M1 has pores of a size, such that particles having a size greater than x μm cannot pass therethrough, syringe 212b of second collection module 210b now contains filtered sample including particles of a size less than x μm. Subsequently, positive pressure is introduced into syringe 212b of second collection module 210b, and a negative pressure/vacuum is introduced into syringe 212c of third collection module 210c, which is connected to the compartment immediately downstream of second membrane M2. The filtered sample in syringe 212b is expelled therefrom to pass through second membrane M2. If second membrane M2 has a pore size such that particles having a size greater than y μm cannot pass therethrough, syringe 212c of third collection module 210c will now contain filtered sample including particles of a size less than y sm. This process can proceed in series through the m membranes.

The backwash functionality remains essentially the same as described above, but is not restricted to being the final step of the process. In that regard, a backwash can occur every other filtration step. In a representative example, of separation into three fractions using system 10, after filtered sample is passed through second membrane M2 and into syringe 212c of third collection module 210c, backwash fluid can be introduced into port 3 to pass through second membrane M2 and into syringe 212b of second collection module 210b. Backwash fluid can then be passed into port 1 to pass through first membrane M1 and into syringe 212a of first collection module 210a. The associated valving can be controlled as described above with any modifications necessary as clear to those skilled in the art. At the end of this process, syringe 212a will contain particles having a size greater than x μm, syringe 212b will contain particles having a size in the range of x-y μm, and syringe 212c will contain particles having a size less than y μm.

As described above, a slight modification in system 10 (for example, modification of control module 100 and flow system module 200 thereof) is required in the above-described alternative process to provide for more comprehensive control of collection containers/syringes of the collection modules of the flow system module. Once again, collection containers/syringes of the collection module needs to be able to access positive and negative pressure as described above. Functionality is added to the collection containers/syringes of the control modules since they can function as intermediary containers in the filtration process.

Algorithms for operating system 10 may be embodied in software that is stored in a memory system and executable by a processor system in operative connection with the memory system (see FIG. 5). The processor system and memory system may be components of electronic circuitry 190 within housing 110 or be distributed in one or more computers external to housing 110 in operative connection with the components of electronic circuitry 190 within housing 110. As known in the computer arts, a user interface (including, for example, a display, a keyboard, a mouse, a speaker and/or one or more other date input/output systems) and a communication system may be in operative connection with the processor system. Various communication/data signals may be communicated in a wired, wireless or combination of wired and wireless manner. In a number of embodiments, the software is designed to receive user-defined values to control system 10. In summary, the software-based control regulates the vacuum and air pressures as well as the delivery of regulated air to each reservoir (via ports 112 designated R in FIG. 2). The software-based control also controls the pneumatics that actuate the pneumatic pinch valves. In control of module system 200, each of syringe reservoirs 212, 212′, and 212a-g have pressure or vacuum applied for a user-selected length of time to allow the desired volumes pass through with each run. In a number of embodiments, every fluidic flow profile is categorized as a ‘state’. Each state defines the specific air pressure and vacuum set points as well as an on-off configuration for each valve. The system cycles first through a sample delivery state in which the fluid loaded in sample module S (for example, a biological fluid) is caused to flow through port 1 of device 410 and leaves through port 7. The sample state is followed by a series of backwash states that proceed sequentially from the bottom to the top (in the illustrated orientation) of device 410 (that is, from lowest particle size range to largest particles size range). The software-based control can also receive other inputs by users for additional states, as needed.

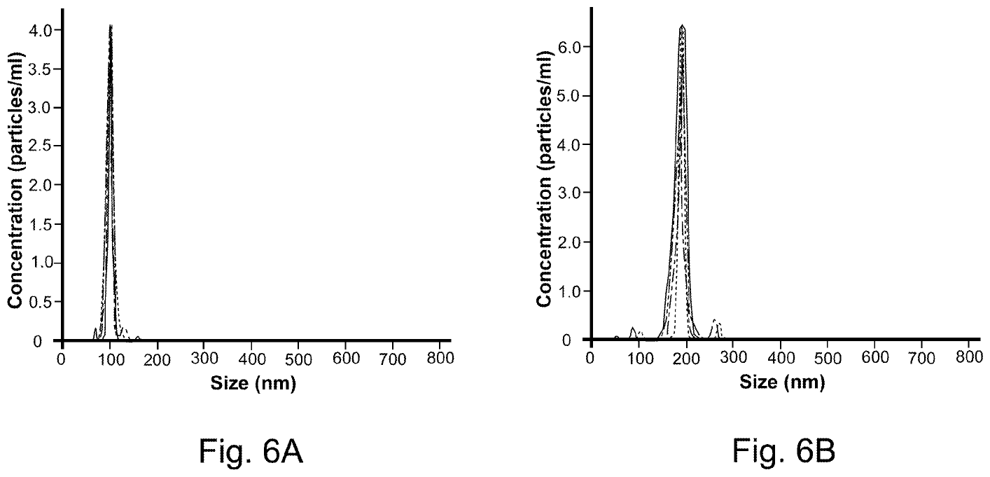

In representative examples of a sample fractionation, system 10 was used in the isolation of 100 nm and 200 nm nanobeads with a total run time 55 seconds and a sample volume of 3 mL. The results of those representative examples are illustrated in FIGS. 6A and 6B. In those representative examples, multiple independent trials were run in which 100 nm or 200 nm beads of known densities (obtained from Thermo Fisher) were passed through system 10. The collected materials were characterized for size distribution and concentration using a particle tracking system (NanoSight NS300). As illustrated in FIGS. 6A and 6B, both isolated fractions demonstrated 100 nm and 200 nm size distributions, respectively, as single peaks around the actual diameter of tested beads. There were minimal, if any, spillovers to other sizes beyond what was expected. In addition, all beads were observed to be in the correct concentrations (approximately 10⁸ particles/mL). The representative examples clearly demonstrated the utility of system 10 for precise, contemporaneous, and high-yield isolation of, for example, nano-sized particles at expected size fractions.

The systems, devices, and methods hereof provide a number of significant advantages and additional functionality when compared to currently available systems devices, and methods. For example, multiple size ranges of particles can be separated contemporaneously in system 10. For example, system 10 provides the ability to isolate all four EV fractions from any given biological fluid (in vitro, ex vivo, human-derived, animal-derived). Moreover, system 10 allows the user to precisely control the size-specificity through use of porous membranes of choice (rather than dealing with size estimates). System 10 provides “untouched”, label-free, and contemporaneous (or the same period of time/sample run time) isolation (for example, of EV). System 10 also provides automated extraction, thereby reducing, minimizing, or eliminating inter-experimental and inter-user variability. Further, system 10 may provide relatively high isolation throughput. For example, system 10 can isolate EVs in multi-liters (as opposed to several microliters) of test samples flow per minute. Moreover, membrane/filtration saturation is prevented in system 10 as a result of cyclic backwash steps during isolation that remove and collect captured particles. Still further, system 10 enables relatively short run times (which, for example, may be measured in seconds as opposed to minutes, hours, or days). In the case of separation of relatively small particles, system 10 may, for example, be readily miniaturized to allow setup and use in smaller spaces.

The membranes in a representative example of system 10 had pore sizes in the range of 100 nm-10 μm. However, such membranes can readily be replaced with user-defined or user-chosen membranes of different pore sizes. Larger pore sizes (for example, 25 μm-200 μm) may, for example, be used to translate from EV isolation into cellular multi-fractionation. For example, embodiments of systems hereof (sometimes referred to as HIMISFRA-Cell) can be readily deployed for isolation (and subsequent characterization) of large and non-large senescent cells from any desired tissue/organ from a human or an animal source. The practical applications of the use of systems, devices, and methods hereof in cellular fractionation are considerable. For example, embodiments of systems, devices, and methods hereof may be utilized for extraction of large non-senescent cells (for example, cardiomyocytes, neurons, etc.) from healthy tissues. Moreover, the technologies hereof may complement emerging single-cell technologies for OMICs analysis, such as scRNA-seq, for better mapping and profiling of cells. The study of large cells is often disregarded in many settings, including tissue senescence, as a result of limitations of currently available tools and methods. As such, an ability to precisely and size-specifically isolate larges cells can better enable the biomedical research field in their discoveries. System parameters such as conduit dimensions, syringe size, flow rates, pressures, system states, etc. will vary depending upon a particular separation to be effected and are readily determined and/or optimized using standard engineering principles and routine experimentation.

The pneumatics in the systems hereof can be readily replaced with alternative pressurizing/control systems and/or syringes or other fluid reservoirs (for example, using electromechanics and/or hydraulics). Likewise, solenoid valves can be replaced with non-solenoid valves. The porous membranes can be made of a variety of material (considering, for example, biocompatibility). In the studied embodiments of system 10, mixed cellulose ester porous membranes were used. Once again, the membrane pore sizes can be varied broadly to provide different separations or separations of higher resolution and different fractionation profile. Multi-fractionation device 10 can be made from various materials other than PDMS materials, including, but not limited to, other polymeric materials (for example, polycarbonate, thermoplastic polymers, etc.) and glass. As set forth above, the number of membranes, associated membrane chambers, as well as the number of sample, backwash and collection modules can be readily adjusted based on the needs of a particular separation or fractionation. The number of ports in fluid connection with the compartments created by the membranes hereof has been minimized by delivery of sample fluid and backwash fluid through ports shared with the collection modules. However, ports separate from collection ports but which are also in fluid connection with the membrane compartments may be used for delivery of sample fluid and/or backwash fluid. Although, the systems, devices, and methods hereof have been described specifically in the fractionation of biological entities or particles such as EVs and cells, one skilled in the art appreciates that the systems, devices, and methods hereof may also be used in the separation and fractionation of systems of nonbiological entities or particles over a broad range or entity/particle size via size exclusion.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

1. A system for fractionating multiple fractions of particles from a sample on the basis of particle size, comprising:
a fractionation unit comprising a flow channel divided into two or more compartments by one or more membranes of known pore size,
a flow module system in fluid connection with the fractionation unit comprising a sample container for containing the sample, a backwash container for containing a backwash fluid, and two or more collection containers for collection of fractionated portions of the sample, each of the two or more collection containers being in fluid connection with a different one of the compartments, and
a control system in operative connection with the flow module system to control flow of the sample to the fractionation unit from the sample container, flow of backwash fluid to the fractionation unit from the backwash container, and flow of fractionated portions of the sample from the fractionation unit to each of the two or more collection containers.

2. The system of claim 1 wherein the fractionation unit comprises a series of m membranes axially spaced along the length of the flow channel dividing the flow channel into m+1 compartments, each of the m membranes having a different pore size, wherein the pore size of the m membranes decreases along the length of the flow channel in the direction of flow of the sample therethrough, wherein the flow module system comprises m+1 collection containers, and the control system is configured to place each of the m+1 collection containers in fluid connection with a different one of the m+1 compartments, wherein m is an integer.

3. The system of claim 2 wherein the control system is configured to deliver the sample from the sample container to a first of the series of m+1 compartments, which is upstream from a first of the membranes having the largest pore size, via control of pressure within the sample container and control of an on-off configuration of a sample container valve in fluid connection with an outlet of the sample container and with the first of the series of m+1 compartments so that a fluid of the sample flows through each of the series of m membranes and fractions of particles in the fluid are excluded from passage through each of the series of m membranes on the basis of particle size.

4. The system of claim 3 wherein the control system is configured to deliver backwash fluid from the backwash container into each of the m+1 compartments downstream from the first of the membranes to backwash each of the m membranes via control of pressure in the backwash container and independent control of an ON-OFF configuration of each of a plurality of backwash valves in fluid connection with an outlet of the backwash container, each of the plurality of backwash valves also being in fluid connection with a different one of the m+1 compartments downstream from the first of the m membranes.

5. The system of claim 4 further comprising m+1 collection valves, each of the m+1 collection valves being in fluid connection with an outlet of a different one of the m+1 collection containers and with a different one of the m+1 compartments, the control system being configured to independently control an ON-OFF configuration of each of the m+1 collection valves to place each of the m+1 collection containers in fluid connection with a different one of the m+1 compartments.

6. The system of claim 5 wherein the control system is further configured to independently control pressure within each of the m+1 collection containers.

7. The system of claim 6 wherein the control system is configured to create a positive pressure within the sample container when the sample is delivered to the fractionation unit and to create a positive pressure within the backwash container when backwash fluid is delivered to the fractionation unit.

8. The system of claim 7 wherein the control system is configured to create a negative pressure in one of the m+1 collection containers when the one of the m+1 collection containers is in fluid connection with an associated one of the m+1 compartments via an ON configuration of the one of the m+1 collection valves in fluid connection with the outlet of the one of the m+1 containers.

9. The system of claim 8 wherein the control system is configured to allow flow into the one of the m+1 collection containers in fluid connection with the one of the m+1 compartments downstream from the last of the series of m membranes during delivery of the sample to the fractionation unit.

10. The system of claim 9 wherein the control system is configured to cause backwash fluid to be delivered to each of the m+1 compartments downstream from the first of the m+1 membranes sequentially after flow of the sample to the fractionation unit is stopped and to allow flow into the one of the m+1 collection containers in fluid connection with the one of the m+1 compartments upstream from the one of the m+1 compartments into which backwash fluid is being delivered.

11. The system of claim 10 wherein the control system is configured to first cause backwash fluid to be delivered to the one of the m+1 compartments downstream of the last of the series of m membranes and then sequentially deliver backwash fluid to each of other m+1 compartments downstream from the first of the m+1 compartments, proceeding from downstream to upstream.

12. The system of claim 8 wherein the control system is configured to allow flow into the one of the m+1 collection containers in fluid connection with the one of the m+1 compartments downstream from the first of the series of m membranes during delivery of the sample to the fractionation unit.

13. The system of claim 12 wherein the control system is configured to allow flow between any two of the m+1 collection containers that are in fluid connection with adjacent ones of the m+1 compartments downstream from the first of the series of m membranes.

14. The system of claim 12 wherein the control system is configured to create a positive pressure in the upstream one of the two of the m+1 collection containers and to create a negative pressure in the downstream one of the two of the m+1 collection containers to cause flow from the upstream one of the two of the m+1 collection containers to the downstream one of the two of the m+1 containers.

15. The system of claim 1 wherein the control system comprises a processor system in operative connection with a memory system, the memory system having one or more algorithms stored therein and executable by the processor system to control flow of sample to the fractionation unit from the sample container, and flow of backwash fluid to the fractionation unit from the backwash container, and flow of fractionated portions of the sample from the fractionation unit to each of the two or more collection containers.

16. The system of claim 15 wherein the control system controls flow of sample to the fractionation unit from the sample container, flow of backwash fluid to the fractionation unit from the backwash container, and flow of fractionated portions of the sample from the fractionation unit to each of the two or more collection containers.

17. The system of claim 15 wherein the one or more algorithms are further executable by the processor system to control flow from collection containers downstream from the first of the one or more membranes to the fractionation unit.

18. The system of claim 15 wherein the m membranes are sized to fractionate particles in the range of 1 nm to 100 μm, to fractionate differently sized extracellular vescicles, or to fractionate differently sized cells.

19.-20. (canceled)

21. The system of claim 18 wherein the control system is configured to achieve microfluidic control through the fractionating unit.

22. (canceled)

23. The system of claim 15 wherein the control system is configured for input of data of state values to the control system to control one or more of flow of sample to the fractionation unit from the sample container, flow of backwash fluid to the fractionation unit from the backwash container, flow of fractionated portions of the sample from the fractionation unit to each of the two or more collection containers, and flow from collection containers downstream from the first in the series of membranes to the fractionation unit, automatically.

24.-25. (canceled)

26. A method for fractionating multiple fractions of particles from a sample on the basis of particle size, comprising:
providing a fractionation unit comprising a flow channel divided into two or more compartments by one or more membranes of known pore size,
providing a flow module system in fluid connection with the fractionation unit comprising a sample container for containing the sample, a backwash container for containing a backwash fluid, and two or more collection containers for collection of fractionated portions of the sample, each of the two or more collection containers being in fluid connection with a different one of the compartments, and
controlling, via a control system in operative connection with the flow module system, flow of sample to the fractionation unit from the sample container, flow of backwash fluid to the fractionation unit from the backwash container, and flow of fractionated portions of the sample from the fractionation unit to each of the two or more collection containers.

27. The method of claim 26 wherein the fractionation unit comprises a series of m membranes axially spaced along the length of the flow channel dividing the flow channel into m+1 compartments, each of the m membranes having a different pore size, wherein the pore size of the m membranes decreases along the length of the flow channel in the direction of flow of the sample therethrough, wherein the flow module system comprises m+1 collection containers, and the control system is configured to place each of the m+1 collection containers in fluid connection with a different one of the m+1 compartments, wherein m is an integer.

28. The method of claim 27 wherein the control system is configured to deliver the sample from the sample container to a first of the series of m+1 compartments, which is upstream from a first of the membranes having the largest pore size, via control of pressure within the sample container and control of an on-off configuration of a sample container valve in fluid connection with an outlet of the sample container and with the first of the series of m+1 compartments so that a fluid of the sample flows through each of the series of m membranes and fractions of particles in the fluid are excluded from passage through each of the series of m membranes on the basis of particle size.

29. The method of claim 28 wherein the control system is configured to deliver backwash fluid from the backwash container into each of the m+1 compartments downstream from the first of the m membranes to backwash each of the m membranes via control of pressure in the backwash container and independent control of an ON-OFF configuration of each of a plurality of backwash valves in fluid connection with an outlet of the backwash container, each of the plurality of backwash valves also being in fluid connection with a different one of the m+1 compartments downstream from the first of the m membranes.

30.-50. (canceled)

51. A fractionation unit comprising a series of m porous membranes axially spaced along the length of a flow channel dividing the flow channel into m+1 compartments, each of the m porous membranes having a different pore size, wherein the pore size of the m porous membranes decreases along the length of the flow channel in the direction of flow of a sample therethrough, wherein m is an integer.

52.-53. (canceled)
